(19) United States
(12) Patent Application Publication
(10) Pub. No.: US 2005/0018839 A1
(43) Pub. Date: Jan. 27, 2005

(54) Electronic device cradle organizer

(76) Inventor: William Bruce Weiser, Meridian, ID (US)

Correspondence Address: Robert C. Klinger;Jackson Walker LLP, Suite 600, 2435 North Central Expressway, Richardson, TX, 75080, US

(21) Appl. No.: 10/625,433

(22) Filed: Jul. 23, 2003

(51) Int. Cl. H04M 1/00

(52) U.S. Cl. 379/454

(57) ABSTRACT

The present invention discloses an electronic device cradle organizer comprising a base, a plate adapted to be secured to a top portion of the base, and wiring positioned within the base.

### FIELD OF THE INVENTION

The present invention relates to electronic device cradles and, more particularly, to an electronic device cradle organizer.

### BACKGROUND OF THE INVENTION

An electronic device cradle, such as a Personal Digital Assistant (PDA) cradle or a mobile phone (or cellular phone) cradle, is generally used to recharge the electronic device's battery via a DC adapter as the electronic device sits in the cradle. There are various situations when placing multiple electronic device cradles in one area is desirable. Conventional attempts to provide such a feature require the number of power adapter units and DC outlets to be equal to the number of electronic devices that are to be recharged. Further, multiple sets of wiring (some as long as six feet, for example) are needed which often results in DC adapter tangles and difficulty in assessing which adapter corresponds with which cradle.

Several industrial handheld manufacturers offer multiple slot cradles that are custom designed to only fit only their models, while the major electronic device suppliers do not offer multiple slot cradles. It is therefore desirable for the present invention to overcome the limitations and problems described above that are involved with electronic device cradles.

### SUMMARY OF THE INVENTION

The present invention achieves technical advantages as an electronic device cradle organizer that supports and powers multiple electronic device cradles to minimize exposed wiring and organize the operation of cradling multiple electronic devices in one area.

In one embodiment, an electronic device cradle organizer comprises a base, a plate adapted to be secured to a top portion of the base, and wiring positioned within the base.

In another embodiment, an electronic device cradle organizer comprises a base adapted to hold a plurality of cradles, a plate adapted to be positioned through a portion of the plurality of cradles and secured to a top portion of the base, a power supply, and wiring adapted to connect the power supply to the plurality of cradles, wherein the wiring is positioned within the base.

In a further embodiment, a method for organizing electronic devices comprises placing a plurality of cradles on a base, placing a detachably attached plate through a portion of the cradles and on to a top portion of the base, and placing a plurality of electronic devices through the plate and on to the cradles.

### BRIEF DESCRIPTION OF THE DRAWINGS

FIG. 1 illustrates an electronic device cradle organizer in accordance with an exemplary embodiment of the present invention; and

FIG. 2 illustrates a method for organizing electronic devices in accordance with an exemplary embodiment of the present invention.

### DETAILED DESCRIPTION OF THE INVENTION

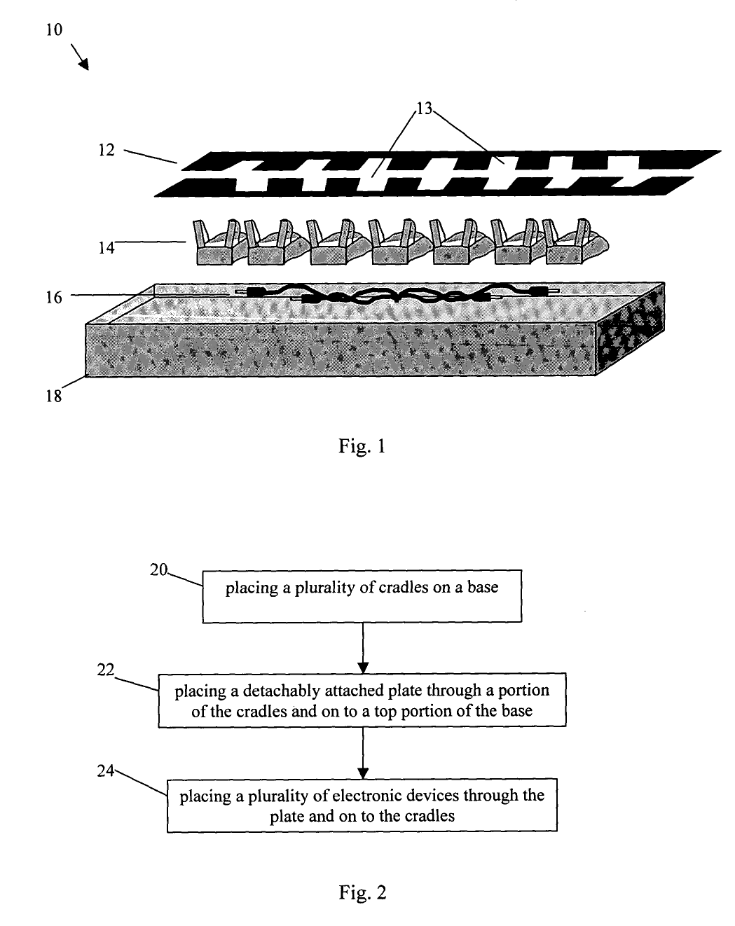

Referring now to FIG. 1, an electronic device cradle organizer 10 of the present invention is presented. The cradle organizer 10 comprises a top plate 12 (comprising cut-out portions 13), cradle wiring 16, and a base or enclosure 18 that may hold one or more individual cradles 14. Each of the cradle wiring 16, which are intermediate DC power cords, are used to connect to each of the cradles 14, and more specifically to each of the cradle power input jacks. The wiring 16 may further be voltage coded to match certain electronic device cradle requirements The enclosure 18 contains at least one power supply (not shown) coupled to the wiring 16 and to at least one DC power adapter or cord (not shown), and, optionally, to at least one data connection cable (not shown). The at least one power supply is sufficient in size to provide the DC power required for the multiple PDA cradles 14. The DC power adapter and the optional data connection cable exit the enclosure 18 and can be respectively coupled to an DC outlet and to other electronic components, such as a PC.

The cradle organizer's 10 top plate 12 can be designed and sculpted in a multitude of various shapes, lengths, widths, heights, and thickness in order to accommodate a plurality of different manufacturers' PDAs or other electronic devices that are able to utilize a cradle. Such a feature permits the cradle 10 to become an easily customizable, re-usable, and user configurable organizational device that includes a common base unit 18 with accommodating power and wiring. Such a design further eliminates the need to use individual power adapters for every cradle. Rather, the individual cradles are held in a fixed and aligned position with the top plate 12 and within or on the base 18 that contains and conceals the individual cradle wiring.

An advantage of the present invention is to organize cradles provided by electronic device manufacturers into a multi-station cradle without the need for expensive tooling set up by that manufacturer or a third party. Electronic device cradle designs are changed often (for example, every six months) making specific multi-slot cradle development and tooling cost prohibitive. The present invention utilizes an approach whereby single cradles provided by an electronic device manufacturer are accommodated with low cost power connect and shaped plates to accommodate them. As cradles are changed by the electronic device manufacturer, the only update to the cradle organizer 10 may be an inclusion of a new shaped plate.

It should be noted that the present invention does not prohibit the use of any electronic device and electronic device cradle function such as, but not limited to, synchronizing the electronic device and a PC through the data connection cable via a Universal Serial Bus or a serial interface.

Referring now to FIG. 2, a method for organizing electronic devices comprises placing a plurality of cradles on a base at step 20, placing a detachably attached plate through a portion of the cradles and on to a top portion of the base at step 22, and placing a plurality of electronic devices through the plate and on to the cradles at step 24.

Although an exemplary embodiment of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

Some of these rearrangements, modifications, and substitutions include, for example, the number of cradles 14 and wires 16 that can be supported by the base 18 and by the organizer 10 in general can be a lower or higher number than those depicted. Also, the top plate 12 (including the cut-out portions 13), as well as the base 18, can be configurable and thus be made longer, shorter, wider, narrower, etc. to set a desired length, height, and width of the plate 12 and/or the base 18 to accommodate various cradles (both old and new) from different manufacturers. Further, different cradles may be utilized in a common base by utilizing a fixed top plate with appropriate cut-outs or by utilizing a configurable top plate. Still further, certain wiring, such as the data connection cable may not be necessary, if certain wireless interfaces, such as Bluetooth, Wi-Fi, etc., were utilized.

1. An electronic device cradle organizer, comprising:
a base;
a plate adapted to be secured to a top portion of the base; and
wiring positioned within the base.

2. The organizer of claim 1 wherein the base is adapted to further hold one or more cradles.

3. The organizer of claim 2, wherein the plate is adapted to further secure the one or more cradles in a fixed and aligned position.

4. The organizer of claim 2, wherein each of the one or more cradles is adapted to hold an electronic device.

5. The organizer of claim 2, wherein the wiring is adapted to couple to the one or more cradles.

6. The organizer of claim 1 further comprising at least one power supply housed within the base and coupled to the wiring.

7. The organizer of claim 6 further comprising at least one power adapter adapted to couple to the at least one power supply, wherein the adapter exits the base.

8. The organizer of claim 6 further comprising at least one data connection cable adapted to couple to the at least one power supply, wherein the cable exits the base.

9. The organizer of claim 1, wherein the plate is adapted to be sculpted in a plurality of at least one of a following form from a group consisting of:
shapes;
lengths;
widths;
heights; and
thickness, in order to accommodate a plurality of different manufacturers' electronic devices.

10. The organizer of claim 1, wherein the base is adapted to be sculpted in a plurality of at least one of a following form from a group consisting of:
shapes;
lengths;
widths;
heights; and
thickness, in order to accommodate a plurality of different manufacturers' electronic devices.

11. The organizer of claim 1, wherein the electronic device is a Personal Digital Assistant.

12. The organizer of claim 1, wherein the electronic device is a mobile phone.

13. The organizer of claim 1, wherein the electronic device is a combination Personal Digital Assistant and mobile phone.

14. An electronic device cradle organizer, comprising:
a base adapted to hold a plurality of cradles;
a plate adapted to be positioned through a portion of the plurality of cradles and secured to a top portion of the base;
a power supply; and
wiring adapted to connect the power supply to the plurality of cradles, wherein the wiring is positioned within the base.

15. The organizer of claim 14 further comprising a plurality of cut-out portions within the plate.

16. The organizer of claim 15, wherein electronic devices are adapted to be placed in the cradles through the cut-out portions.

17. The organizer of claim 14, wherein the plate is configurable.

18. The organizer of claim 14, wherein the plate is detachably attached to the base.

19. The organizer of claim 14, wherein the plate is adapted to receive electronic devices from different manufacturers.

20. The organizer of claim 14, wherein the base is configurable.

21. The organizer of claim 14, wherein the base is adapted to accommodate various cradles from different manufacturers.

22. The organizer of claim 14, wherein the wiring may be voltage coded to match certain cradle requirements.

23. A method for organizing electronic devices, comprising:
placing a plurality of cradles on a base;
placing a detachably attached plate through a portion of the cradles and on to a top portion of the base; and
placing a plurality of electronic devices through the plate and on to the cradles.

24. The method of claim 23 further comprising providing power to the plurality of cradles via a single adapter.
